(19) United States
(12) Patent Application Publication
(10) Pub. No.: US 2006/0137124 A1
(43) Pub. Date: Jun. 29, 2006

(54) Non-woven roller covers

(75) Inventors: Ricky L. Dilyard, Smithville, OH (US); Gary L. Leisure, Wooster, OH (US)

Correspondence Address: MCNEES, WALLACE & NURICK LLC, 100 PINE STREET, P.O. BOX 1166, HARRISBURG, PA, 17108-1166, US

(73) Assignee: The Wooster Brush Company, Wooster, OH (US)

(21) Appl. No.: 11/151,166

(22) Filed: Jun. 10, 2005

Related U.S. Application Data
(60) Provisional application No. 60/639,830, filed on Dec. 28, 2004.

(51) Int. Cl. B05C 17/02

(52) U.S. Cl. 15/230.11; 492/29

(57) ABSTRACT

A re-usable, shed-resistant roller cover for use with paint and other heavy liquids is provided. One embodiment provides a non-woven roller cover material. This roller cover material includes a single outer layer or ply of non-woven material that replaces the knitted or woven fabrics typically utilized for paint roller covers. Another embodiment provides a single-ply, non-woven roller cover attached to a stable substrate, i.e., a backing material. The stable substrate provides a degree of dimensional stability to the roller cover and prevents or reduces “necking” that can result in the formation of gaps on the roller core. A third embodiment provides a single-ply, non-woven roller cover (with or without a backing material) attached to a rigid core that provides structural support to the roller cover.

### CROSS-REFERENCE TO RELATED APPLICATIONS

This patent application claims the benefit of U.S. Provisional Patent Application Ser. No. 60/639,830 filed on Dec. 28, 2004 and entitled “Non-Woven Paint Roller Covers,” the disclosure of which is incorporated by reference as if fully rewritten herein.

### BACKGROUND OF THE INVENTION

The present invention relates in general to painting implements useful for the application of paints, stains, solvents and other priming or finishing liquids, and more particularly to roller covers for use with paint rollers and the like, wherein the roller covers partially or wholly comprise non-woven materials. The roller covers of this invention are useful for painting a variety of surfaces, including walls, ceilings, and floors of various compositions and textures. These roller covers also exhibit certain desirable characteristics, such as the ability to absorb or otherwise capture the paint or other material to be applied from a reservoir of liquid (typically a roller tray), the ability to retain suitable amounts of such material as the roller is moved from such reservoir to a point near the surface to be painted or otherwise coated, and the ability to release the material being applied as the roller rotates while in contact with surface to be coated.

Commercially available paint roller covers are typically designed for attachment to a substantially cylindrical rotating cage or frame and are usually manufactured in predetermined sizes and lengths. Furthermore, the material from which the roller cover is constructed is often impervious to the liquids to be applied and can usually be cleaned after a single use so that at least one re-use of the roller cover is possible. Roller cover material is typically manufactured in varying densities and thickness, i.e., pile, so as to be suitable for the specific fluid characteristics of the paint or other material being used and for the nature of the surface to be coated or otherwise treated. For obvious reasons, any tendency of roller cover material to shed or deposit, during application, small fibers or threads from the exterior portion of the paint roller onto the surface being coated is highly undesirable.

Prior art paint rollers are usually made of one or more knitted fabrics that are constructed by twisting thousands of fibers into strands that are then knitted or otherwise attached to a backing material. Certain other roller covers are made from woven materials fabricated on looms and then attached to a backing layer of one type or another. Both knitted and woven fabrics have the tendency to shed to varying degrees depending on the depth and density of the fabric, the characteristics of the coating material being applied, and the character of the surface being coated. Moreover, the manufacture of knitted and woven materials is often labor-intensive, thereby resulting in higher overall costs and reduced profitability. Thus, the composition of roller covers and the methods of manufacture associated therewith, both impact the ability to make quality roller covers at affordable prices. Ideally, paint roller covers are inexpensive and reusable so as to be accessible either by the professional or the layperson using such products. Thus, there is a need for an alternate roller cover material that does not shed, that can be used to make roller covers quickly and inexpensively, and that meets other predetermined or pre-identified quality criteria and characteristics.

### SUMMARY OF THE INVENTION

Deficiencies in and of the prior art are overcome by the present invention, the exemplary embodiment of which provides an inexpensive, re-usable, shed-resistant roller cover for use with paint and other heavy liquids. In accordance with a first aspect of this invention a non-woven roller cover material is provided. This roller cover material includes a single outer layer or ply of non-woven material that replaces the knitted or woven fabrics typically utilized for paint roller covers. In accordance with a second aspect of this invention, a single ply, non-woven roller cover attached to a stable substrate, i.e., a backing material, is provided. The stable substrate provides a degree of dimensional stability to the roller cover and prevents or reduces “necking” that can result in the formation of gaps on the roller core. In accordance with a third aspect of the present invention, a single-ply, non-woven roller cover (with or without a backing material) attached to a rigid core that provides structural support to the roller cover is provided. In this and other embodiments, the non-woven roller cover material may be spirally wrapped onto the core using known roller construction technology.

Additional features and aspects of the present invention will become apparent to those of ordinary skill in the art upon reading and understanding the following detailed description of the exemplary embodiments. As will be appreciated, further embodiments of the invention are possible without departing from the scope and spirit of the invention. Accordingly, the drawings and associated descriptions are to be regarded as illustrative and not restrictive in nature.

### DETAILED DESCRIPTION OF THE INVENTION

This invention relates to a shed-resistant cover for use with a paint roller or similar device. A first general embodiment of the present invention provides a non-woven roller cover material. This roller cover material includes a single outer layer or ply of non-woven material that replaces the knitted or woven fabrics typically utilized for paint roller covers. A second general embodiment of the present invention provides a single-ply, non-woven roller cover attached to a stable substrate, i.e., a backing material. The stable substrate provides a degree of dimensional stability to the roller cover and prevents or reduces “necking” that can result in the formation of gaps on the roller core. A third general embodiment of the present invention provides a single-ply, non-woven roller cover (with or without a backing material) attached to a rigid core that provides structural support to the roller cover. In this and other embodiments, the non-woven roller cover material may be spirally wrapped onto the core using known roller construction technology (see discussion below).

In the exemplary embodiments described herein, the roller covers of the present invention are substantially cylindrical in shape and are intended for use with standard paint rollers and frames. This characteristic should not be construed in a limiting sense because non-woven materials may be incorporated into painting implements having other configurations and geometries. The non-woven roller covers of this invention typically include an even or “homogeneous” surface, i.e., the surface of the roller cover does not include a pre-determined three-dimensional pattern or any other characteristic for the purpose of creating an image or predetermined geometric pattern on the surface being painted.

With respect to this invention, the term “non-woven” refers to a sheet, matrix, or web of fabric or material that is created by bonding and/or interlocking fibers, yarns, or filaments using mechanical, thermal, chemical, solvent means, or other means. The term “fiber” is used in its generic sense, and refers to yarns, threads, filaments, and the like, as well as to actual fibers. In various embodiments of the present invention, the non-woven web includes or may include multiple blends of natural and/or synthetic fiber or filaments including, but not limited to, single component or bi-component fibers, filaments or yarns of varying weight, cross section or thickness, density, elongation, tensile strength, shrinkage, air permeability, Taber abrasion, denier, staple length, structure, and melt characteristics. The term “denier” refers to the weight in grams of 9,000 meters of a filament or yarn. “Staple length” refers to fiber/filament cut length. In one or more exemplary embodiments of this invention, the non-woven material includes a denier of about 0.8 to 40; a cut length from about 0.2 inches to 7.5 inches plus continuous filament; a tenacity of about 1.0 to 7.5 grams/denier, an elongation of about 10% to 125%; a heat set temperature of about 0° C. to 200° C.; and a shrinkage of about 0% to 10%. Other ranges and values are possible and will be determined by the particular combination of fibers used to create non-woven materials that are intended for different applications.

The natural fibers that are compatible with present invention include: wool, cotton, flax, and silk fibers and combinations thereof. The synthetic fibers that are compatible with the present invention include: polyester (polyethylene terepthalate), polypropylene, polyethylene, nylon (polyamide), acrylic, modacrylic, rayon, acetate, PCT, PETG, and combinations thereof. In certain embodiments, a heat-set fiber or a “binder” fiber is incorporated into the fiber web. This binder fiber acts as an inter-fiber adhesive because the softening point of the binder fiber is typically less than the other fibers it is blended with. Therefore, including binder fibers in a non-woven blend results in a more uniform bonded structure when the non-woven material is exposed to a low temperature by fusing the binder fiber with the adjacent synthetic or natural fibers. The inclusion of a binder fiber also holds or stabilizes the pile of the roller cover and reduces shrinkage of the roller cover during the assembly process.

In embodiments of the present invention that include a substrate in the form of a stable backing material, the substrate includes: paper, phenolic impregnated paper, olefin sheets, urethane foams, cloth, metallic(s), elastomer(s), non-woven materials, or combinations thereof. Other materials are possible. The non-woven material may be attached or bonded to the substrate by mechanical means, chemical means, thermal means, solvent means, sonic means, or other more specific means including, but not limited to, resin bonding, saturation print, spray, foam (e.g., polyester, polyether), powder bonding, fusion, air, calender, spun lace (hydro-entanglement), or combinations thereof.

In embodiments wherein the non-woven cover material, either with or without a substrate is attached to a core, the core may include, but is not limited to, the following materials: non-woven materials, wood; paper; impregnated phenolic resin paper; silica; metal (and similar materials); paper/olefin composites; olefin sheets; polyolefin sheets; extruded plastic such as polypropylene, polyethylene, polyethylenetelephthalate (PET), polyvinyl chloride (PVC), thermoplastic rubber (TPR), thermoplastic elastomer (TPE), nylon, glass filled nylon, and acetal; plastic ribbon/sheet, such as polypropylene, polyethylene, PET, PVC, TPR, TPE, nylon, glass filled nylon, and acetal. The non-woven material may be attached or bonded to the core by mechanical means, chemical means, thermal means, solvent means, adhesive means, sonic means, or other more specific means that include the use of epoxy, urethanes, cyanoacrylates, hot melts, thermoplastic resins (such as polypropylene, polyethylene, TPR, TPE, PET, PVC, nylon, and acetal), powder bonding, radio waves, UV, ultrasound, and microwaves.

Having generally described this invention, a further understanding can be obtained by reference to certain specific examples detailed below, which are provided for purposes of illustration only and are not intended to be all inclusive or limiting unless otherwise specified.

A first specific exemplary embodiment of the non-woven material of the present invention provides a blend that comprises 90% 7-denier PET in a 76 mm staple length and 10% T-110 binder fiber. This blend is about 12 ounces per square yard and is typically gray in color. A second specific exemplary embodiment of the non-woven material of the present invention provides a blend that comprises 90% 9-denier PET (high heat set and high crimp) in a 76 mm staple length and 10% T-110 binder fiber. This blend is about 12 ounces per square yard and is typically white in color. A third specific exemplary embodiment of the non-woven material of the present invention provides a blend that comprises 45% 4.75-denier PET (high heat set and high crimp) in a 76 mm staple length; 45% 6.70-denier PET (high heat set and high crimp) in a 76 mm staple length, 10% T-110 binder fiber. This blend is typically white in color. All three of these exemplary blends may be fabricated in pile heights of 3 mm, 5 mm, or 7 mm. Other pile heights are possible.

In each of the embodiments disclosed herein, the webs of non-woven fabric can be manufactured using one or more known manufacturing technologies. Such process technologies include, for example: (i) web formation systems such as dry lay, wet lay, air lay (rando web), cross lapping, carding, random carding; (ii) resin to web systems such as spun-bond, and melt blown, and (iii) spun lace hydro-entanglement. Web consolidation determines the characteristics of the non-woven fabric and such consolidation is achievable by friction bonding resulting from a needling operation. In some cases, the finishing of the non-woven fabric or fabrics used in the various embodiments of the present invention creates the final desired characteristics of such non-woven fabric.

Another exemplary process useful for manufacturing the non-woven materials of the present invention is referred to as a “needle punch” process. The needle-punch process typically uses barbed needles to transport fiber in a fiber mat or web from the horizontal to the “Z” direction, causing fiber entanglement or fiber interlocking. This process includes the use of a series of machines, the operation of which is coordinated to provide a continuous processing of one or more fiber types into a finished fabric. The series of machines typically includes: feeders, openers, a card, a crosslapper, needle looms, edge slitters, and a winder.

The needle punch process begins with the feeders and the openers, which are designed to regulate the flow of fiber into the system. Fiber clumps are reduced in size to enhance consistency of flow, and bundles of crimped fiber are ‘opened’ to expose as many individual fibers to the carding process. Fiber finish, which is a processing aid in the form of a liquid overspray, may be applied during these initial stages of preparing the fibers. Fiber input is electronically metered throughout this stage, to enhance weight consistency at the beginning of the web forming, i.e., carding, step. The prepared fibers are then transferred to the card, which includes a number of rotating rolls that are covered with saw-toothed wire and set very close together. The fiber passes through the rolls and alternates between points where either combing or transferring takes place. This series of combing and transferring steps, creates a continuous, uniform web of fibers that weighs about one ounce per square yard and that is uniform in width and appearance. This web of fibers is then removed from the card and transferred to the crosslapper.

The crosslapper is a series of carrying aprons that receives the carded non-woven web and delivers it to the needling process in a series of layers. These layers or ‘laps’ of fabric are built up on a continuously moving floor apron, set at right angles to the lapper. The weight and width of the fabric can be varied by adjusting the speed of the floor apron, and width of the laydown. The ability to control weight and width at the crosslapper, gives each needling line the flexibility to run many fabric constructions.

The needling step begins when the layered fabric is transferred to the first needle loom, which is called a tacker or preneedler. Multiple needle looms are frequently included in an assembly line and the number and type of looms determines the needling capabilities of each line. The fabric is passed through each loom at a precisely controlled speed by two pair of rollers called, input and output rolls. Inside each loom, the needles are mounted in plates that are bolted to a beam that moves up and down at high rate of speed to permit the needles to ‘punch’ the fabric. Two plates, the stripper plate and bed plate, which are drilled to match the needle pattern, hold the fabric as it passes through and permit control of the depth of needle penetration. Most looms perform conventional needling using needles referred to a “felting” needles. However, in some lines, the last loom contains “fork” needles that create a pile structure on the fabric surface. Instead of a bed plate, these looms typically use a slotted lamella plate (velour), or a moving brush bed (stratos). At the completion of the needling process, the non-woven fabric is slit to the finished width, wound into rolls, and packaged for delivery. Some assembly lines include a “hot can” device. Prior to slitting and winding, the fabric is exposed to the surface of the can, and the temperature is controlled to provide the desired amount of densification and/or fusing of the back surface of the fabric.

Attaching the non-woven material to the core, and assembling the roller cover may be accomplished by implementing the processes disclosed in U.S. Pat. Nos. 6,159,134 and 5,572,790 (both issued to Sekar). U.S. Pat. Nos. 6,159,134 and 5,572,790 are hereby incorporated by reference, in their entirety, into this disclosure. In the embodiments of the present invention that include solid cores, the methods and devices disclosed in U.S. Pat. No. 6,231,711 issued to Roberts et al., U.S. Pat. No. 6,199,279 issued to Humphrey et al., and U.S. Pat. No. 5,537,745 issued to Musch et al. (all assigned to the Wooster Brush Company), may be utilized in part or in whole to construct the roller covers. U.S. Pat. Nos. 6,231,711 6,199,279 and 5,537,745 are hereby incorporated by reference, in their entirety.

Use of the non-woven paint roller covers of the present invention include the following advantages: (i) the use of non-woven materials and process technologies offers significant cost savings in the manufacture of shed-resistant paint rollers due to high speed manufacturing capability, high output, no knitting or weaving requirement, and ease of recycling; (ii) the use of non-woven process technology allows for a wider selection and end use of fibers and/or filaments that are not typically compatible with knitted and woven industrial pile fabric formulations; (iii) the use of non-woven materials offers versatility in that the non-woven materials can be easily formulated and blended using various fiber combinations to enhance the performance of a roller cover for a wide range of coating applications, including the use of solvents, glues, adhesives, and epoxies; (iv) the use of non-woven process technology allows for the integration of multiple non-woven materials and processes to be used in the manufacture of a paint roller cover; and (v) non-woven materials may be easily color-coded to correspond to specific materials and applications. Additionally, the use of non-woven fabrics or materials allows for the creation of roller covers that are as effective as woven roller covers, but at a significantly lower pile height and density. For painting applications, certain non-woven materials are known to exhibit a 65% release rate (of paint), as compared to a 45% release rate for woven materials.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A roller cover, comprising:
(a) a core, wherein the core further comprises a first surface and a second surface; and
(b) a non-woven material attached to at least one of the first surface and the second surface, and wherein the non-woven material further comprises:
(i) a plurality of fibers, wherein the plurality of fibers further comprise natural fibers, synthetic fibers, or a combination thereof; and
(ii) wherein the plurality of fibers have been interconnected by mechanical means, chemical means, thermal means, solvent means, or a combination thereof.

2) The roller cover of claim 1, further comprising a backing material, wherein the non-woven material is attached to the backing material, and wherein the backing material is attached to the substrate.

3) The roller cover of claim 2, wherein the backing material further comprises: paper, phenolic impregnated paper, olefin sheets, urethane foams, cloth, metal, elastomer, non-woven material, or a combination thereof.

4) The roller cover of claim 2, wherein the non-woven material is attached to the backing by mechanical means, chemical means, thermal means, solvent means, sonic means, or a combination thereof.

5) The roller cover of claim 1, wherein the core further comprises a rigid material.

6) The roller cover of claim 1, wherein the core further comprises: non-woven material, wood, paper, impregnated phenolic resin paper, silica, metal, paper composites, olefin sheets, polyolefin sheets, polypropylene, polyethylene, polyethylenetelephthalate, polyvinyl chloride, thermoplastic rubber, thermoplastic elastomer, nylon, glass filled nylon, acetal, or combinations thereof.

7) The roller cover of claim 1, wherein the non-woven material is attached to the core by mechanical means, chemical means, thermal means, solvent means, adhesive means, sonic means, or a combination thereof.

8) The roller cover of claim 1, wherein the surface texture of the non-woven material is substantially homogenous.

9) The roller cover of claim 1, wherein the plurality of fibers further comprises single component fibers, bi-component fibers, or a combination thereof.

10) The roller cover of claim 1, wherein the plurality of fibers further comprises at least one binder fiber.

11) The roller cover of claim 1, wherein the natural fibers further comprise wool, cotton, flax, silk, and combinations thereof.

12) The roller cover of claim 1, wherein the synthetic fibers further comprise polyester, polypropylene, polyethylene, nylon, acrylic, modacrylic, rayon, acetate, PCT, PETG, and combinations thereof.

13) A roller cover, comprising:
(a) a core, wherein the core further comprises a first surface and a second surface;
(b) an non-woven material attached to at least one of the first surface and the second surface, and wherein the non-woven material further comprises:
(i) a plurality of fibers, wherein the plurality of fibers further comprise natural fibers, synthetic fibers, or a combination thereof; and
(ii) wherein the plurality of fibers have been interconnected by mechanical means, chemical means, thermal means, solvent means, or a combination thereof; and
(c) a backing material, wherein the non-woven material is attached to the backing material, and wherein the backing material is attached to the substrate.

14) The roller cover of claim 13, wherein the core further comprises a rigid material.

15) The roller cover of claim 13, wherein the core further comprises: non-woven material, wood, paper, impregnated phenolic resin paper, silica, metal, paper composites, olefin sheets, polyolefin sheets, polypropylene, polyethylene, polyethylenetelephthalate, polyvinyl chloride, thermoplastic rubber, thermoplastic elastomer, nylon, glass filled nylon, acetal, or combinations thereof.

16) The roller cover of claim 13, wherein the core is substantially cylindrical in shape.

17) The roller cover of claim 13, wherein the non-woven material is attached to the core by mechanical means, chemical means, thermal means, solvent means, adhesive means, sonic means, or a combination thereof.

18) The roller cover of claim 13, wherein the surface texture of the non-woven material is substantially homogenous.

19) The roller cover of claim 13, wherein the plurality of fibers further comprises single component fibers, bi-component fibers, or a combination thereof.

20) The roller cover of claim 13, wherein the plurality of fibers further comprises at least one binder fiber.

21) The roller cover of claim 13, wherein the natural fibers further comprise wool, cotton, flax, silk, and combinations thereof.

22) The roller cover of claim 13, wherein the synthetic fibers further comprise polyester, polypropylene, polyethylene, nylon, acrylic, modacrylic, rayon, acetate, PCT, PETG, and combinations thereof.

23) The roller cover of claim 13, wherein the backing material further comprises: paper, phenolic impregnated paper, olefin sheets, urethane foams, cloth, metal, elastomer, non-woven material, or a combination thereof.

24) The roller cover of claim 13, wherein the non-woven material is attached to the backing by mechanical means, chemical means, thermal means, solvent means, sonic means, or a combination thereof.

25) An applicator for use with heavy liquids, comprising:
(a) a non-woven material, wherein the non-woven material further comprises:
(i) a plurality of fibers, wherein the plurality of fibers further comprise natural fibers, synthetic fibers, or a combination thereof; and
(ii) wherein the plurality of fibers have been interconnected by mechanical means, chemical means, thermal means, solvent means, or a combination thereof.

26) The applicator of claim 25, further comprising a backing material, wherein the non-woven material is attached to the backing material.

27) The applicator of claim 26, wherein the backing material further comprises: paper, phenolic impregnated paper, olefin sheets, urethane foams, cloth, metal, elastomer, non-woven material, or a combination thereof.

28) The applicator of claim 26, wherein the non-woven material is attached to the backing by mechanical means, chemical means, thermal means, solvent means, sonic means, or a combination thereof.

29) The applicator of claim 25, wherein the surface texture of the non-woven material is substantially homogenous.

30) The applicator of claim 25, wherein the plurality of fibers further comprises at least one binder fiber.

31) A method for making a roller cover, comprising:
(a) creating a core;
(b) creating a non-woven material having predetermined characteristics, wherein the surface texture of the non-woven material is substantially homogenous; and
(c) attaching the non-woven material to the core.

32) The method of claim 31, further comprising the steps of attaching a substrate material to the non-woven material, and attaching the substrate material to the core.

33) The method of claim 31, wherein the backing material further comprises: paper, phenolic impregnated paper, olefin sheets, urethane foams, cloth, metal, elastomer, non-woven material, or a combination thereof.

34) The method of claim 31, wherein the non-woven material is attached to the backing by mechanical means, chemical means, thermal means, solvent means, sonic means, or a combination thereof.

35) The method of claim 31, wherein the core further comprises: non-woven material, wood, paper, impregnated phenolic resin paper, silica, metal, paper composites, olefin sheets, polyolefin sheets, polypropylene, polyethylene, polyethylenetelephthalate, polyvinyl chloride, thermoplastic rubber, thermoplastic elastomer, nylon, glass filled nylon, acetal, or combinations thereof.

36) The method of claim 31, wherein the non-woven material is attached to the core by mechanical means, chemical means, thermal means, solvent means, adhesive means, sonic means, or a combination thereof.

37) The method of claim 31, wherein creating the non-woven material further comprises: dry lay, wet lay, air lay, cross lapping, carding, random carding, spun-bond, melt blown, spun lace hydro-entanglement, needle punch, or combinations thereof.
